(19) United States
(12) Patent Application Publication
(10) Pub. No.: US 2012/0132207 A1
(43) Pub. Date: May 31, 2012

(54) REBREATHER SETPOINT CONTROLLER AND DISPLAY

(75) Inventor: Philip Edward Straw, El Granada, CA (US)

(73) Assignee: HELIOX TECHNOLOGIES, INC., Redwood City, CA (US)

(21) Appl. No.: 13/110,816

(22) Filed: May 18, 2011

Related U.S. Application Data
(62) Division of application No. 11/579,015, filed on Oct. 30, 2006, now abandoned.
(60) Provisional application No. 60/567,288, filed on Apr. 30, 2004.

(51) Int. Cl. A62B 7/10

(52) U.S. Cl. 128/205.12

(57) ABSTRACT

An oxygen setpoint controller (SPC) and a user's display for a rebreathing apparatus wherein the user exhales oxygen depleted breath into a closed rebreathing loop, the CO2 is scrubbed from the exhaled gases, oxygen is added to the rebreathing loop to maintain the oxygen at a specified partial pressure, and the oxygen enhanced gases in the rebreathing are provided to the user. The SPC is able to detect the failure of any of the oxygen sensors and provide an alarm condition to the user. The SPC further operates to provide dive data such as rate of ascent, time of dive, depth, and PPO2 to the uses, and to store and retain dive data for further review. The SPC further provides numerical dive data to a heads up display (HUD). The HUD further includes a tricolor LED displaying selected analog parameters.

### CROSS REFERENCE TO RELATED APPLICATIONS

The present application is a division of commonly owned, co-pending U.S. application Ser. No. 11/579,015, filed Oct. 30, 2006. The present application claims priority from each of the following applications which are U.S. application Ser. No. 11/579,015, filed Oct. 30, 2006, under 35. U.S.C.§371 as entering national stage from PCT International Application No. PCT/US2005/014734, filed May 2, 2005, as a non-provisional application of U.S. Provisional Application No. 60/567,288, filed Apr. 30, 2004, all of which are incorporated herein by reference for all they contain.

### BACKGROUND OF THE INVENTION

1. Field of the Invention

The present invention relates generally to self-contained breathing apparatus and more particularly to monitoring of the partial pressure of oxygen in carbon dioxide depleted exhalant within a rebreather apparatus.

2. Description of the Related Art

Self-contained breathing apparatus may typically be used by people, such as firefighters, rescue workers, miners, chemical plant workers or divers, who encounter hazardous environments in which normal respiration is not possible. These known breathing apparatus may be one of several types; open circuit, closed circuit, or semi-closed circuit.

An example of the open circuit type is the self-contained underwater breathing apparatus (SCUBA) worn by underwater divers. SCUBA equipment typically includes one or more compressed air tanks, a pressure regulator to reduce the pressure of the compressed air from tank storage pressure to a pressure that can allow for normal inhalation by a user of the provided air or inhalant, and the necessary hoses and mouthpiece to enable the user to breath the air at the reduced pressure. The exhaled breath, or exhalant, is expelled to the surrounding environment resulting in a loss to the user of all exhaled air.

As is well known, air is a mixture of gases and its two largest components are nitrogen (N₂) and oxygen (O₂) which have partial pressures at atmospheric conditions of 78% and 21% respectively. The partial pressure is an indication of the volume of a component gas of a gas mixture, as known through Dalton's Law of Partial Pressures. Other gases comprise the remaining amount including carbon dioxide (CO₂) at 0.033%. During respiration, the exhalant leaving a person's lungs contains 14% O₂ and 4.4% CO₂. Therefore, a user will consume only 7% of the inhaled volume, and all the exhaled volume is exhausted to the environment.

Because only 7% of the inhaled volume is consumed during respiration, and all of the exhaled volume is exhausted, 93% of the aspirated air is “wasted”. A second type of self-contained breathing apparatus, known as a rebreather, overcomes this air “wastage”. A rebreather overcomes this “wastage” by removing the CO2 from the exhalant, adding oxygen to replace the oxygen consumed by the user, and recycling the CO2 depleted, oxygen augmented exhalant back to the inhalant.

There are two types of rebreathers; a semi closed circuit rebreather (SCCR) that provides a constant or a manually adjustable flow of oxygen from a reservoir of compressed oxygen through a valve into an inhalant counterlung for mixing with the CO₂ depleted exhalant, and a closed circuit rebreather (CCR) that automatically adjusts the volume of makeup O₂ as a function oxygen content of the exhalant to maintain a specified partial pressure of oxygen (PPO₂) of the inhalant. This specified PPO₂, or PPO₂ setpoint, may be fixed or user adjustable to provide the user with sufficient oxygen for specific conditions.

Both the SCCR and the CCR types also have a second supply of compressed gas, a diluent gas, to maintain the rebreather loop gas volume as a user descends in water, and this diluent gas may be compressed air or other mixtures of gases that enable a user to operate at greater depth. The diluent gas may be added automatically or manually by the user to maintain gas volume when descending or when gas is deliberately exhausted from the system. The diluent gas is usually coupled with a gas buffer or exhalant counterlung by means of valve.

Each type of rebreather is well known and fully described in the art. For example, see U.S. Pat. No. 5,924,418 issued Jul. 20, 1999 to John E. Lewis of Rancho Pales Verde, California, U.S. Pat. No. 6,003,513 issued Dec. 21, 1999 to Peter Francis Readey and Michael J. Cochran of Plano, Texas, and U.S. Pat. No. 6,712,071 issued Mar. 30, 2004 to Martin John Parker of Great Britain.

### SUMMARY OF THE INVENTION

This application is directed to the monitoring of the of the oxygen content of the exhaled gas and the controls for injecting oxygen into the exhaled gas to maintained a specified oxygen content of the gas breathed by the user in a closed circuit rebreather. Although rebreathers may be used in a variety of hazardous environments, this invention will be described in the context of underwater environments.

A rebreather comprises a closed breathing loop to capture a user's exhaled gases, to direct the exhaled gases to an exhalant counterlung for receiving the exhaled gases, to remove or “scrub” CO₂ from the exhaled gases in a scrubber coupled with the exhalant counterlung, to inject oxygen into the scrubber, to direct the oxygen enriched breathable gas to an inhalant counterlung, and a mouthpiece coupled to the inhalant and exhalant counterlung for providing breathable gas to the user. The user's lungs provide the energy to circulate the gas around the breathing loop, and one-way valves located in either the mouthpiece or the counterlung couplings ensure the gas flow within the closed breathing loop is unidirectional. Oxygen sensors located within the scrubber enclosure measure the partial pressure of oxygen (PPO2) in the exhaled gases.

The oxygen sensors provide signals representing the PPO2 of the exhaled gas to the setpoint controller (SPC) in which the actual PPO2 can be compared with the desired PPO2. The difference between the actual PPO2 and the desired PPO2 is then used to control the oxygen injection valve to inject oxygen into the scrubber housing to maintain the desired PPO2. The desired PPO2 may be entered manually using a controls handset or the desired PPO2 may be the result of a computer program resident in the SPC to monitor the user's stress.

The SPC drives the oxygen injection valve in accordance with the desired PPO2 and the measure PPO2 in the exhaled gases. The SPC also comprises a microprocessor for storing operational data, providing data to user displays, storing and running decompression models, calibrating the oxygen sensors, and providing alarms and alerts to the user. A handset controller displays selected systems parameters and the values of each of three oxygen sensors, and buttons on the handset controller allows the user to change the desired PPO2 setpoint and display a cycle of systems parameters. The SPC also controls the intensity of the display backlighting as a function of depth or user input. A tri-color light emitting diode may the light source and its intensity may be controlled using a pulse width modulator. Further, the color of the display may be changed, the intensity of the display may be increased, the backlighting may be flashed, or a combination of these may be used to indicate an alarm condition to the user.

The SPC also provides signals to a heads-up display. The heads-up display will display the PPO2 setpoint and other selected parameters. In addition to displaying numerical values, the PPO2 may also be displayed by a tri-color light emitting diode in which the PPO2 or another selected variable will be displayed as a color continuum. Alarm conditions may be shown by flashing colors or a white light.

The oxygen sensors, SPC, the oxygen injection valve, and batteries are located in a watertight chamber in the scrubber canister. A wired or wireless network may provide communications between the SPC and all the sensors, displays and devices thereby reducing the system susceptibility to noise and improving the rebreather performance and reliability. Because the radio frequencies used for wireless networks do not propagate in water, the closed breathing may serve as a wave guide.

These and other features, aspects and advantages of the present of the present invention will be more fully understood from a study of the Detailed Description of the Invention when read in conjunction with the attached Drawing and appended Claims.

### BRIEF DESCRIPTION OF THE DRAWINGS

FIG. 1 is a schematic representation of the setpoint controller showing the interconnections to the oxygen injection solenoid, oxygen sensors, and display devices;

FIG. 2 illustrates the states of the SPC and the transitions therebetween; and

FIG. 3 is a schematic cross sectional view of a scrubber with a temperature sensor bus in accordance with the present invention.

### DETAILED DESCRIPTION OF THE INVENTION

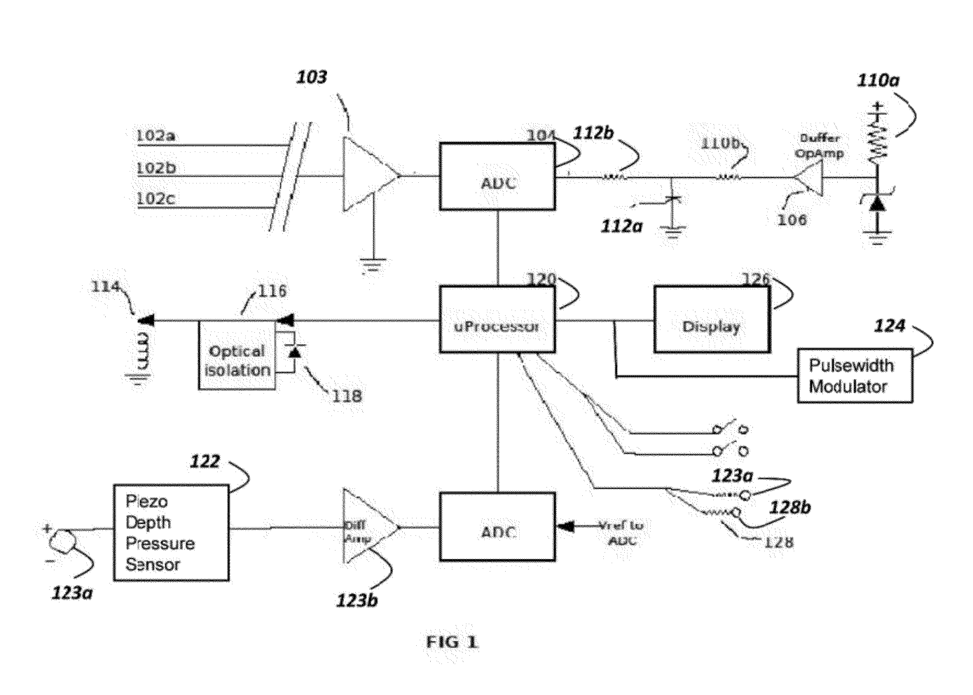

A setpoint controller (SPC) 100 is shown in FIG. 1. Three raw oxygen sensors 102_{a-c} (e.g., Teledyne R22) provide voltage signals proportional to partial pressure of oxygen (PPO2). Three buffer amplifiers, one such amplifier 103 being shown, amplify and an analog to digital converter 104 converts these analog signals to digital signals for use by the SPC 100 and display 126 to the user. The SPC 100 also provides error detection by comparing the output of each oxygen sensor 102_{a-c} with each of the oxygen sensors 102_{a-c}, and selecting a value in which two of the three oxygen sensors 102_{a-c} agree with each other within specified parameters. Should an output value of any one of the oxygen sensors 102_{a-c} indicate oxygen content falls outside the comparison parameters with the other two oxygen sensors 102_{a-c}, that particular one of the oxygen sensors 102_{a-c} is presumed to have failed and is excluded from further use.

Because most voltage regulators are not sufficiently accurate to compensate for battery voltage decay through current usage, a precision voltage reference provides increased accuracy. A simplified diagram for the precision voltage reference 109 is shown comprising a common amplifier 106, a reference Zener diode 108, and two resistors 110_{a-b}. The ratio of the two resistors 110_{a-b} controls the gain of the amplifier 106. A low pass filter, typically including capacitor 112 and an optional resistor 113, is also provided to remove any extraneous system noise. Because most oxygen sensors are noisy, the instrument amplifier requires common mode rejection of noise from the sensor signals. Providing common mode rejection by using low pass filters or software averaging is well known in the art.

The oxygen injection solenoid 114 is also shown partially in FIG. 1. Two optical power FET drivers supply energizing current to the oxygen injection solenoid and two digitally activated diodes provide dispersion of counter-emf generated by deenergizing the solenoid. A digitally activated diode may be simply a FET used as a switch, turned on and off by the SPC μProc, 120 allowing current to flow through the diode.

By placing a capacitor between the resistor and the input from the μProc, and tying the capacitor to ground it is possible use pulse width modulation to get a variable output using the correct optical isolator. Most solenoid applications require a clean rise and fall of the binary input.

To drive the solenoid open, the optical isolator 116 and the reverse bias diode 118 are digitally activated. When the coil is deenergized, the coil generates a counter-emf current that is quickly dissipated by the reverse bias diode 118. Dissipating the counter-emf current eliminates the biasing of the ground reference thereby providing more reliable solenoid closing. A reverse bias diode 118 also provides the possibility to drive some solenoids in a reverse direction thereby forcing a normally closed solenoid to a partially or fully open condition. Rapid pulsing between the open an closed positions may eventually free a stuck solenoid. The reverse bias diodes on each drive (operated as appropriate for each drive) increase the reliability of most solenoids, thereby mitigating problems with stuck solenoids as known in the current art. A separate ground for the solenoid drive circuit is used minimize or eliminate sensor noise.

A pressure sensor 122 is provided for sensing barometric pressure to aid the calibration process. The pressure sensor 122 may conventionally be a Wheatstone bridge having a piezoelectric element which changes resistance in response to pressure. The bridge is driven by a constant current source 123ₐ and provides an output voltage to differential amplifier 123_{b}. The oxygen cells 102_{a-c} are calibrated by using a known gas having an oxygen content as close to the proposed setpoint as possible. As currently known in the art, the user automatically injects the known gas to flush the rebreather prior to calibrate the oxygen cells. The user then waits for a period of time before calibrating the cells. The pressure sensor 122 senses the loop pressure and determines when the loop returns to barometric pressure, thereby minimizing the calibration wait time.

By closing the loop after the oxygen flush, the solenoid 114 can overpressure the loop to check for air leaks. The loop pressure may be monitored over a period of time to detect leaks. The loop pressure may also be set to a specific pressure for oxygen calibration. The SPC 100 also checks the oxygen cell linearity. Calibration can be checked by injecting diluent, or by breaking open the rebreather loop at the cells to allow air over the sensor face.

The display 126 having a backlight is coupled to the SPC 100. The backlight is conventionally a light emitting diode or another similar mechanism that is driven by modulator 124 which may conventionally include an amplifier, a timing capacitor and digital potentiometers to control the duty cycle and period. The SPC 100 is then able to control the intensity of backlighting depending upon the intensity of external light by sensing the external light, or user commands. Another means of control is to adjust the backlight as a function of depth knowing less light is needed at depth and hence providing power savings. An additional benefit to the user is a control means to limit light intensity when in low light situations thereby preventing night blindness. The backlight may be activated by the user, by depth, or by light intensity.

The SPC 100 also monitors battery voltages. In the event of a low battery voltage situation, the backlight could be illuminated or dimmed. Additionally to conserve power and to avoid operating the system to failure, the SPC 100 may lower the setpoint to minimize or stop the oxygen injection. The primary display on the SPC 100 will be turned off and a secondary system is used instead informing the user that setpoint control is still working inside bounds.

The set point controller 100 further comprises a ‘wet switch’ 128 or water sensor for SPC activation. The wet switch 128 pulses an output to an output pin 128ₐ into the water and observes the response on an input pin 128_{b}. If the SPC 100 is in water, an input pulse will be observed on the input pin 128_{b}, and the SPC 100 will be activated. The SPC 100 can also determine the salinity of the water by observing the response to the output pulse over a known distance from the output pin 128ₐ to the input pin 128_{b}. The water salinity provides a correction factor for under water depth adjustment for fresh or variable amounts of salt water.

Time keeping can be tracked for dive time using either the depth sensor 122 or wet switch 128 as a start and end condition. Time tracking is known in the art for such applications. The timing signal also drives a counter and upon a counter overflow condition, causes a processor interrupt. This allows very accurate timing of the solenoid injects. This timer can be adjusted as per the setpoint control logic.

While in an inactive state, the SPC 100 monitors the oxygen and detects breathing on the loop. Breathing detection, wet contact, or depth automatically activates the SPC 100. Wet contact or depth activation may be switched off manually whereas breathing detection is constantly active.

Because total CO2 production and therefore scrubber absorption is related to oxygen use, the total oxygen injection time and the depth can be correlated to signify stress, CO2 increase, or workload. Timing the total oxygen injection activity provides an accurate tracking of the use of the scrubber if measured with depth. Correlation of this information with depth can give an approximation of scrubber life left, or use to date if the scrubber mechanics were previously understood. This value could be used to alert the user to a low remaining scrubber life, with an indication that the user should surface to replenish the scrubber or to recheck calibration as required.

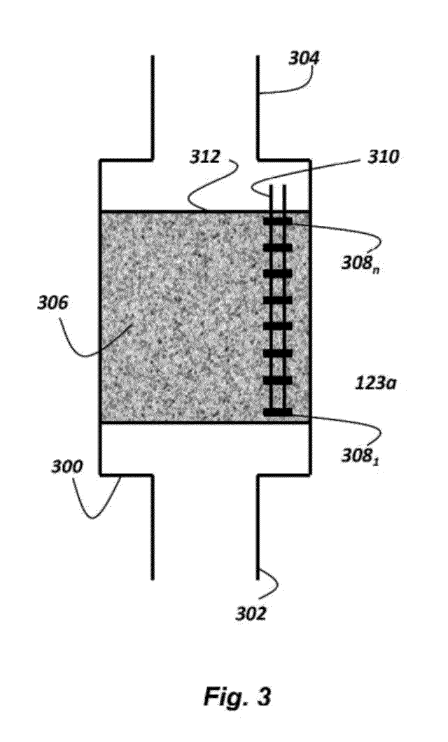

As seen in FIG. 3, a scrubber 300 includes an inlet 302, an outlet 304 and a CO₂ absorbent material 306 disposed intermediate the inlet 302 and outlet 304. Scrubbing CO₂ is an exothermic reaction and generates heat and the temperature of an axial scrubber can be monitored. A novel way of sensing the scrubber temperature with precision is by using use of a strip or printed circuit board of solid state temperature sensors 308₁₋ₙ on a data bus 310 mounted along the axis of the scrubber 300. For example I2C data bus sensors are available. Radial scrubbers could use the same technique with an alternative arrangement of sensors. These temperature sensors 308₁₋ₙ identify the location of the warm front of the reaction of the following cold front thereby providing the breadth of the hot front.

At depth, the breadth of the hot front will increase to process and completely remove CO₂, and determining the unused amount of the CO₂ absorbent material 306 in the scrubber that is left that is limits the maximum time before the reaction reaches an end portion 312 of the absorbent material 306 closest to the outlet 304 of the scrubber 300 causing release of CO₂ into the rebreather loop. As the diver moves from depth to the shallows the warm front can move backwards because the lower density gas can be scrubbed in less flow volume (e.g., length in an axial scrubber).

This movement up the absorbent material 306 allows for an increased time of use (having ascended) before the front reaches the end of the absorbent material 306. This data is presented in terms of duration remaining and maximum depth of use of the scrubber in current conditions. Rate of progression of the front for a given depth can be taken and extrapolated to give an end of lifetime. A safe exit for a depth is determined by comparing the “ceiling” of ascent (when ascent limitations are known, for example, as a result of a decompression model computation) and compared to the “lifetime” of the scrubber 300.

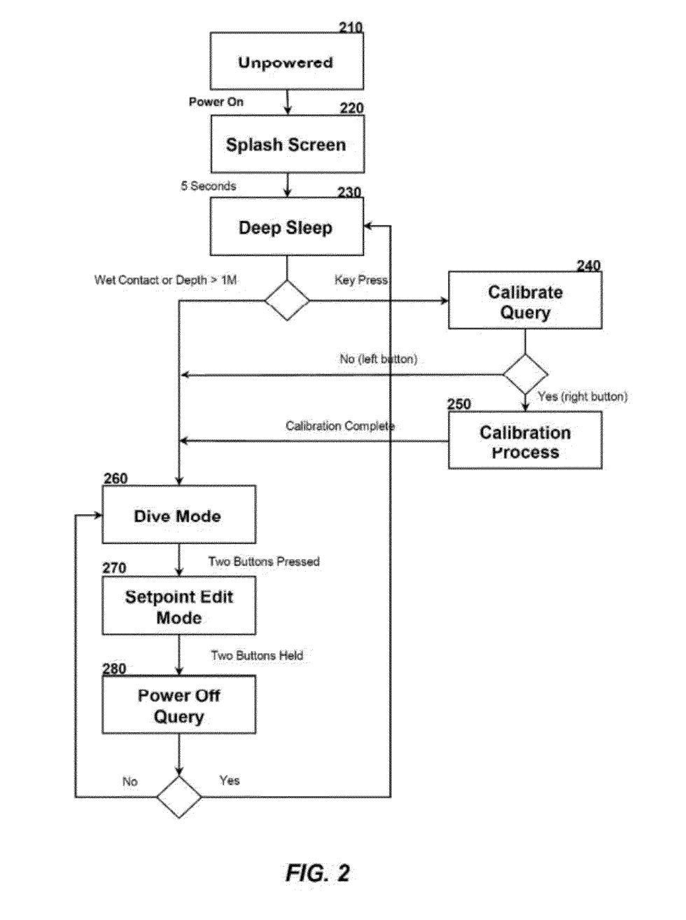

The controls handset is the user interface (UI) comprising a display screen and two user depressible buttons for transitioning from state to state and is usually located remotely from the SPC typically on the user's wrist. The states for the SPC are shown in FIG. 2. In the unpowered condition 210, the display screen is blank. Upon powering, a splash screen 220 is presented to the user to confirm the SCP is active. After five seconds, the SPC reverts to a deep sleep 230 and again presents a blank screen to the user. Upon a second key press, the SPC queries the user 240 whether to proceed to the calibration process 250. The user presses the right button to calibrate 250 and the left button to proceed to the dive mode 260. When the calibration process completes, the SPC is now locked in the dive mode 260. The user depresses both buttons to unlock the dive mode 260 enter the setpoint edit mode 270 and allows the user to change the PPO2 setpoint. Pressing one button or the other raises or lowers the PPO2 setpoint. If both buttons are held for longer than three seconds, the SPC queries the uses whether to turn off the power 280. Upon the proper response from the user, the SPC returns the deep sleep state 230. To prevent from accidental off signals the SPC UI asks for a random button to be pressed, so as not to build user habits. If the power off response is not received, the SPC returns to the dive mode 260. The UI always displays PPO2 in the dive mode 260, and depth, time, and ascent rate displays are available to the user.

Alarms and alerts are displayed to the user by flashing the backlight, varying brightness or using different colors to signal different events and alarm warnings.

Component placement is an important consideration for an underwater environment. The oxygen sensors, the oxygen injection valve, the batteries and are located in a dry chamber of the scrubber. However the SPC may be located external to the scrubber. Because the raw signals from the oxygen cells are remote to the SPC, the signals are particularly susceptible to noise, particularly if the sensor signals are co-located on the same wire as the power to a high current device such as the oxygen injection solenoid. To overcome the susceptibility to noise, the oxygen injection solenoid driver is placed adjacent to the solenoid itself. Therefore, the solenoid actuation signal is a low current signal. Alternatively, or in addition to placing the solenoid driver circuitry adjacent to the solenoid, local pre-amplifiers are placed next to the oxygen sensors.

The addition of a current limiting resistor to the reference voltage amplifier can detect water leakage within the SPC. For example, when the resistor is large and salt water leaks into a cable, the resistor acts as a current limiter and the reference voltage would likely be driven to ground. The SPC logic can detect this voltage drop and indicate a water leak.

Another embodiment to reduce noise or the susceptibility to noise is locate the SPC within the scrubber canister.

Still another embodiment to reduce noise is to couple the oxygen sensors, the handset controller, the SPC, and other sensors using a digital communications protocol operating over a wired or a wireless network. A digital protocol is inherently less susceptible to noise, and can operate in noisy environments. Error correction techniques for operating digital communications networks in noisy environments are well known in the art.

While the communications network may be implemented using a wired bus, another implementation is to use a wireless network. Radio waves propagate in air, not water, and a wireless network may propagate its signals in the closed breathing loop. Each device such as the oxygen sensors and SPC would be connected to the network using a radio frequency bridge, and communicate to each other using radio waves in the closed breathing loop. A wave guide separate from the close breathing loop may alternatively be supplied.

Setpoint control is based on an injection period and a duty cycle inside that period. This approach allows the period to be altered to accommodate the minimum injection time at depth, for example by limiting the control by depth and set a smaller injection period. The potential for setpoint overshoot also may be accurately controlled. If the PPO2 is close to the setpoint, the injection duty cycle can be held constant to the oxygen injector minimum opening time and adjusting the period. For example, a depth decrease may cause an increase in the duty cycle for the next specific number of periods.

Another advantage is the ability to reduce the setpoint when it is not possible to achieve the setpoint. Such a condition occurs when the user is on the surface and the setpoint is trying to control a PPO2 of 1.3. Another example is to protect against under-calibration. If, for example, pure oxygen was not available for calibration, and if a user dives to 6M and achieves a displayed 1.8 PPO2, it would be possible to correct the values for mis-calibration or give an alarm.

Over time, calibration values could be stored in the SPC flash memory and compared to show a decay over time or an indication of the cell accuracy in different conditions. The rate of change for the oxygen cell values could be monitored against a known good curve for those conditions. At intervals, the oxygen cells could also be tested by shorting each cell allowing each cell to produce the maximum rated current. Old cells would not be able to reach the rated current, or when the short was removed, would not be able to reach the previous voltage for the PPO2 condition thereby indicating a cell reaching the end of life or another condition of mistrust. This technique is compatible with underwater use and is achieved by using a FET switch and a resistor tuned for the current voltage across the cell such that it passed the maximum current under the cell specification.

The SPC also drives a heads up display located within the user's line of sight. The drive would require balancing resistors to achieve equal brightness on all legs of the LEDs, with a common ground being connected to a pulse width modulator from the SPC to effect overall brightness.

For example a tricolor LED (RGB) could be used to display any range of colors in the spectrum. Discrete use of specific colors show specific conditions, for example blue=cold=hypoxic mix or close, green=near setpoint, red=hot mix=hyperoxic or close. Color changes could be discrete or continuous to indicate condition changes. A different color indicates an alert or calibration display. A hall effect button could be used to make more ambitious function changes in the display if necessary

The LED could be watertight and on the end of a 4 wire cable. By making the plastic slightly opaque on the surface the light is diffused. A reflective section is placed internally within the LED hole to make the whole housing produce a diffused glow and thereby provide a signal to a buddy. The signal is naturally intuitive, qualitative, and easy to read. A flashing LED indicates an SPC failure and the color indicates the value of the PPO2. In addition to the color indication, the flashing rate may also be used to indicate the qualitative value.

The SPC multiple battery sources, for example driver circuit battery is separate from the HUD battery. The batteries are cross-coupled so that power to the HUD could be supplied by the SPC battery thereby enabling a PPO2 monitoring system in the event the HUD battery fails. When the SPC battery in this case decays, the HUD could alert the user with an alert thereby providing an early warning of the solenoid drive battery decay and failure.

Calibration of the HUD could be done on a signal from the SPC controller. It could also be done by monitoring the solenoid drive signal. This could also allow signaling of the oxygen injection valve on the HUD. An example of this would be to look for 10 seconds of requested drive, watch for inactivity on the drive request, wait a small period, then read calibration values.

The PPO2 displayed on the HUD or SPC may be the average of the two closest cells as per the state of the art. Another embodiment is to average all three cells when the values are close. Another embodiment is to discount all untrusted cells as determined by the aforementioned tests. An alarm condition exists when less than two cells are trusted, and this alarm is displayed to the user.

A waterproof data port is provided for establishing electrical or optical connections to other rebreathers or devices. This allows external monitoring of the rebreather conditions, remote control of the SPC, updating of software, or user to user communications. A digital protocol is used on the port, for example I2C or multi-master/multidrop.

There has been described hereinabove novel apparatus, methods and techniques directed to rebreather set point controller apparatus. Those skilled in the art may now make numerous uses of, and departures from, the above described embodiments without departing from the inventive concepts disclosed herein. Accordingly, the present invention is to be defined solely by the lawfully permitted scope of the appended Claims.

I claim:

1. In a closed loop rebreather in which a scrubber, wherein said scrubber has an inlet, an outlet and a CO2 absorbent material disposed intermediate said inlet and said outlet, removes CO2 from exhalant introduced at said inlet and further provides CO2 depleted gas at said outlet, an improvement comprising:
a plurality of temperature sensors disposed in seriatim along CO2 absorbent material, each of said temperature sensors being operative to detect a temperature of said CO2 absorbent material in a region of said CO2 absorbent material proximal thereto;
a processor to which each of said temperature sensors is operatively in communication, said processor being cognizant of a location of each of said sensors relative to an end portion of said absorbent material nearest said outlet and further cognizant of said localized temperature detected by each respective one of said temperature sensors, said processor being operative to compute from said location and said localized temperature a position along said absorbent material of maximum temperature and a distance of said position relative to an end portion of said absorbent material nearest said outlet, said remaining useful life being a function of said distance and rate of progression of said distance toward said end portion.

2. The improvement of claim 1 wherein each of said temperature sensors is spaced equidistantly along a bus operatively connected to said processor.

3. The improvement of claim 2 wherein said bus has a serial data line and a serial address line.

4. The improvement of claim 3 wherein said bus in an IC2 bus.

5. The improvement of claim 1 wherein said processor is further operative to compute a position of minimum temperature following said position of maximum temperature, said remaining useful life further being a function of the distance between said position of minimum temperature and said position of maximum temperature.
